(19) United States
(12) Patent Application Publication
(10) Pub. No.: US 2013/0113986 A1
(43) Pub. Date: May 9, 2013

(54) Lens Driving Device and Lens Driving Method Thereof

(71) Applicant: Ming-Shan Chan, Luzhu Township (TW)

(72) Inventor: Ming-Shan Chan, Luzhu Township (TW)

(73) Assignee: Altek Corporation, Hsinchu (TW)

(21) Appl. No.: 13/354,927

(22) Filed: Jan. 20, 2012

(30) Foreign Application Priority Data
Nov. 9, 2011 (TW) 100140952

(51) Int. Cl. H04N 5/232

(52) U.S. Cl. 348/349; 348/E05.045

(57) ABSTRACT

A lens driving device and a lens driving method thereof The lens driving device comprises an image sensing element used to sense an image of an image pickup target; a focus lens group used to change a focus point of the image; a direct current motor used to drive and move the focus lens group; and a microcontroller electrically coupled to the image sensing element for receiving the image signal, and used to control the direct current motor to drive and move the focus lens group for changing the focus point of the image, such that a contrast ratio of the image signal will change. Also, the microcontroller calculates a contrast value according to the contrast ratio. A process of focusing is completed while the focus lens group is located at a position of a maximum contrast value corresponding to the image signal.

### CROSS-REFERENCE TO RELATED APPLICATION

This application claims the benefit of priority to Taiwan Patent Application No. 100140952, filed on Nov. 9, 2011, in Taiwan Intellectual Property Office, the contents of which are hereby incorporated by reference in their entirety for all purposes.

### BACKGROUND OF THE INVENTION

1. Field of the Invention

The present invention relates to a lens driving device and a lens driving method thereof, in particular to the lens driving device and method using a single direct current motor to perform the zooming and focusing functions.

2. Description of the Related Art

At present, most digital cameras with the zooming and focusing functions generally adopt both a direct current motor and a stepper motor to drive and control the zooming and focusing functions of a lens. Since the direct current motor is driven by the current, and it is difficult to achieve precise control of the motor, only the zooming function can be driven by direct current motor thereby, but not the focusing function. On the other hand, the stepper motor is controlled by the pulse signal, and the stepper motor only performs one step rotation when a pulse signal is inputted, which is much more precise than the direct current motor. And consequently, the stepper motor is used for the focus control. In addition, the lens requires two motors to control the zooming and focusing functions, and the camera also requires two sets of respective control circuits to control and drive the motor, which incurs a higher cost of the camera.

To overcome the aforementioned problems, some digital cameras adopt a single stepper motor to control the zooming and focusing functions simultaneously, seeking to overcome the problems of requiring more motors and control circuits for the camera and incurring a higher cost of the camera. However, the stepper motor has a higher drop current than the direct current motor, so that if both zooming and focusing functions are controlled by the stepper motor, then the battery power of the camera will be exhausted quickly, not only failing to meet the requirements or specification of the number of photos that can be taken by the camera, but also failing to meet the power saving requirements of the camera. Obviously, the aforementioned application cannot meet the demands of the user.

### SUMMARY OF THE INVENTION

In view of the aforementioned problems of the prior art, it is a primary objective of the present invention to provide a lens driving device and a lens driving method thereof to overcome the problems of the prior art that requires the use of both the direct current motor and the stepper motor for the zooming and focusing functions of the camera, and the use of the single stepper motor to control the zooming and focusing functions that incurs a higher cost and a larger power consumption of the camera.

To achieve the aforementioned objective, the present invention provides a lens driving device, comprising an image sensing element, a focus lens group, a direct current motor and a microcontroller. The image sensing element is provided for sensing an image of an image pickup target and generating an image signal. The focus lens group is disposed between the image sensing element and the image pickup target for changing a focus point of forming the image. The direct current motor is provided for driving and moving the focus lens group. The microcontroller is electrically coupled to the image sensing element for receiving the image signal, and controlling the direct current motor to drive and move the focus lens group to change the focus point of forming the image, so as to change a contrast ratio of the image signal, and the microcontroller computes a contrast value according to a contrast ratio. The focus lens group is positioned at a position corresponding to a maximum contrast value of the image signal to thereby completing a process of focusing.

Preferably, in the process of focusing, the focus lens group is driven to move in a direction by the direct current motor, and the microcontroller samples and calculates the contrast value of the image signal for every first interval, and while the contrast value is changing from an incrementing status to a decrementing status, the microcontroller takes a maximum numeric value before changing to the decrementing status as a coarse scan maximum contrast value.

Preferably, in the process of focusing, the focus lens group is driven to move in the opposite direction by the direct current motor controlled by the microcontroller when the microcontroller obtains the coarse scan maximum contrast value, and the microcontroller samples and calculates the contrast value of the image signal for every second interval and records a positioning signal corresponding to each of the contrast value, and if the numeric value of the contrast value is changed from the incrementing status to the decrementing status, the microcontroller takes the maximum numeric value before changing to the decrementing status as a fine scan maximum contrast value, and takes the fine scan maximum contrast value as the maximum contrast value, wherein the second interval is shorter than the first interval.

Preferably, the microcontroller controls the direct current motor to drive the focus lens group to move in the opposite direction, while the microcontroller samples at the first interval and the contrast value decrements from the coarse scan maximum contrast value to a predetermined degree.

Preferably, in the process of focusing, the microcontroller controls the direct current motor to drive the focus lens group to return to a position corresponding to the fine scan maximum contrast value of the image signal to complete the process of focusing according to the recorded positioning signal, when the microcontroller obtains the fine scan maximum contrast value.

Preferably, the microcontroller controls the direct current motor to drive the focus lens group to return to the position corresponding to the fine scan maximum contrast value of the image while the microcontroller samples at the second interval and the contrast value decrements from the fine scan maximum contrast value to a predetermined degree.

Preferably, the lens driving device of the present invention is applicable to a camera apparatus, the focus lens group is installed in a lens of the camera apparatus, wherein the direct current motor drives the lens to rotate, so as to move the focus lens group, and the positioning signal received by an optical receiver of the camera apparatus is a light source reading while the lens is rotated.

Preferably, the lens driving device of the present invention further comprises a zoom lens group, and the microcontroller drives and moves the zoom lens group to perform a zoom motion, wherein the microcontroller drives the focus lens group and the zoom lens group, such that if the direct current motor drives and moves the focus lens group, the zoom lens group remains still, and vice versa.

To achieve the aforementioned objective, the present invention provides a lens driving method, comprising the steps of: sensing an image of an image pickup target by an image sensing element and generating an image signal; receiving the image signal by a microcontroller; controlling a direct current motor by the microcontroller to drive and move a focus lens group, so as to change a focus point of forming the image and change a contrast ratio of the image signal; and computing a contrast value according to the contrast ratio by the microcontroller, and a process of focusing is completed when the focus lens group is positioned at a position corresponding to a maximum contrast value of the image signal.

To achieve the aforementioned objective, the present invention further provides a lens driving device, applicable for a camera apparatus comprising an image sensing element, a zoom lens group, a focus lens group, a direct current motor and a microcontroller. The image sensing element is provided for sensing an image of an image pickup target and generating an image signal. The zoom lens group is installed in a lens of the camera apparatus and disposed between the image sensing element and the image pickup target for adjusting the focal length of the lens to change the distance of forming the image. The focus lens group is installed in the lens of the camera apparatus and disposed between the zoom lens group and the image sensing element for changing the focus point of forming the image. The direct current motor is provided for driving and moving the zoom lens group and the focus lens group. The microcontroller is electrically coupled to the image sensing element for receiving the image signal and controlling the direct current motor to drive and move the zoom lens group, so as to change the distance of forming the image, and complete a zoom motion, or the microcontroller controlling the direct current motor to drive and move the focus lens group, so as to change the focus point of forming the image and change a contrast ratio of the image signal, and the microcontroller computing a contrast value according to the contrast ratio, and when the focus lens group is positioned to a position corresponding to a maximum contrast value of the image signal, the process of focusing is achieved.

In summary, the lens driving device and method of the present invention have one or more of the following advantages:

(1) The lens driving device and method achieve the zooming and focusing functions of the camera by using a single microcontroller and a direct current motor, not only reducing lens components to lower the manufacturing cost, but also reducing the power consumption of the camera battery effectively, so as to meet user requirements.

(2) The lens driving device and method use the microcontroller in the process of focusing to control the direct current motor to drive and move the focus lens group back and forth, and use a quick scan and a fine scan process to determine a maximum contrast value of the image. Such arrangement not only finds the position of the focus point of the image accurately, but also prevents too much time taken for the process of focusing.

### BRIEF DESCRIPTION OF THE DRAWINGS

FIG. 1 is a schematic view of a lens driving device in accordance with a first preferred embodiment of the present invention.

FIG. 2 is a flow chart of a lens driving method in accordance with the first preferred embodiment of the present invention.

FIG. 3 is a schematic view of a lens driving device in accordance with a second preferred embodiment of the present invention.

FIG. 4 is a first schematic view of a lens driving device in accordance with a third preferred embodiment of the present invention.

FIG. 5 is a second schematic view of a lens driving device in accordance with the third preferred embodiment of the present invention.

FIG. 6 is a third schematic view of a lens driving device in accordance with the third preferred embodiment of the present invention.

FIG. 7 is a flow chart of a lens driving method in accordance with the third preferred embodiment of the present invention.

### DESCRIPTION OF THE PREFERRED EMBODIMENTS

The technical characteristics of the present invention will become clear with the detailed description of the preferred embodiments accompanied with the illustration of related drawings as follows. It is noteworthy to point out that the drawings are provided for the purpose of illustrating the present invention, but they are not necessarily drawn according to the actual scale, or are intended for limiting the scope of the invention.

In the lens driving device and method of the present invention, a single direct current motor is provided for performing lens zooming and focusing, and the device and method are applicable for camera apparatus such as digital cameras, smart phones with cameras, and single-lens reflex cameras. Of course, the practical application of the invention is not limited to camera apparatus only.

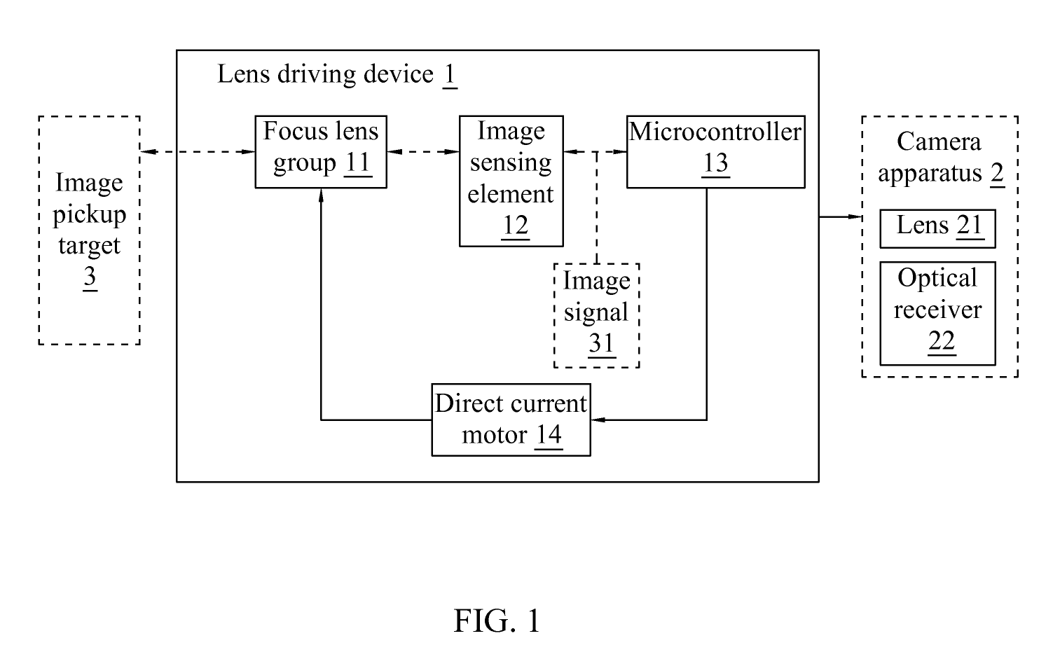

With reference to FIG. 1 for a schematic view of a lens driving device in accordance with a first preferred embodiment of the present invention, the lens driving device 1 comprises a focus lens group 11, an image sensing element 12, a microcontroller 13 and a direct current motor 14. The image sensing element 12 is a sensing element such as a charge-coupled device (CCD) or a complementary metal oxide semiconductor (CMOS) for sensing an image of an image pickup target 3 and generating an image signal. The microcontroller 13 may be a micro control unit (MCU). The microcontroller 13 is electrically coupled to the image sensing element 12 and used for controlling the motion of the direct current motor 14. The lens driving device 1 is installed in a camera apparatus 2. The focus lens group 11 is installed in a lens 21 of the camera apparatus 2, and disposed between the image sensing element 12 and the image pickup target 3 for changing a focus point for forming an image. The direct current motor 14 is provided for driving the focus lens group 11. In addition, the camera apparatus 2 further comprises an optical receiver 22.

From the description above, when the microcontroller 13 receives the image signal 31 sensed by the image sensing element 12, and controls the direct current motor 14 to drive the focus lens group 11 to move back and forth to change the focus point of forming the image, so as to change a contrast ratio of the image signal 31. While the contrast ratio of the image signal 31 is changed, the microcontroller 13 computes a contrast value according to each contrast ratio. If the direct current motor 14 drives and moves the focus lens group 11 and positions the focus lens group 11 at a position corresponding to a maximum contrast value of the image signal 31, the processing of focusing is achieved.

More specifically, the microcontroller 13 controls the direct current motor 14 to drive the focus lens group 11 to move in a direction for performing a coarse scan. In the process of moving the focus lens group 11 in a direction, the contrast ratio of the image signal 31 will be changed. In the meantime, the microcontroller 13 takes a sample of the image signal 31 for every first interval, and computes the contrast value of a contrast ratio corresponding to each sample of the image signal 31. If the numeric value of the contrast value is changed from an incrementing status to a decrementing status, the microcontroller 13 will take the maximum numeric value before the decrementing status as a coarse scan maximum contrast value. If the microcontroller 13 obtains a coarse scan maximum contrast value or the coarse scan maximum contrast value is decremented to a predetermined degree, the microcontroller 13 will control the direct current motor 14 to drive the focus lens group 11 to move in the opposite direction to perform a fine scan. In the process of moving the focus lens group 11 in the opposite direction, the microcontroller 13 will take a sample of the image signal 31 for every second interval, compute the contrast values corresponding to each sample of the image signal 31 and record a positioning signal corresponding to each contrast values. If the contrast value of a sample taken by the microcontroller 13 for every second interval is changed from an incrementing status to a decrementing status, the microcontroller 13 will take the maximum numeric value before changing to the decrementing status as the fine scan maximum contrast value. Since the microcontroller 13 performs a fine scan motion while the focus lens group 11 is moving in the opposite direction, the a second interval is smaller than the first interval, so as to obtain a more accurate maximum contrast value, wherein the fine scan maximum contrast value is greater than or equal to coarse scan maximum contrast value, and the fine scan maximum contrast value is considered as the aforementioned maximum contrast value. If the microcontroller 13 obtains a fine scan maximum contrast value or the fine scan maximum contrast value is decremented to a predetermined degree, the microcontroller 13 will control the direct current motor 14 to drive the focus lens group 11 to return to a position corresponding to the fine scan maximum contrast value of the image signal 31, so as to complete the process of focusing according to the recorded positioning signal. Wherein, the direct current motor 14 drives the lens 21 to rotate in order to move the focus lens group 11, and the positioning signal is a light reading received by an optical receiver 22 of the camera apparatus 2 while the lens 21 is rotated.

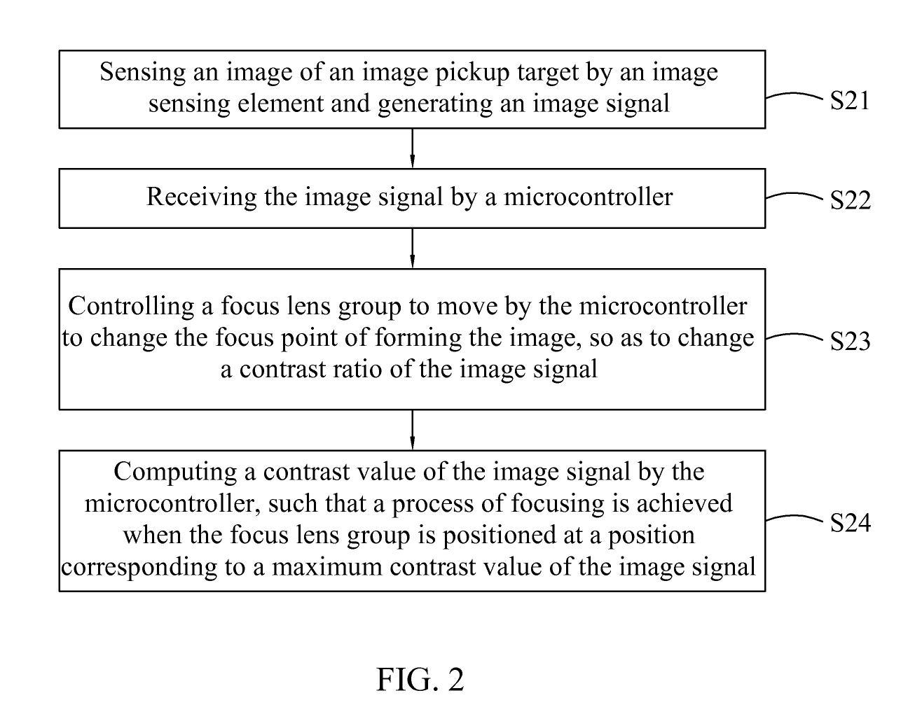

With reference to FIG. 2 for a flow chart of a lens driving method in accordance with the first preferred embodiment of the present invention, the lens driving method comprises the following steps:

S21: Sensing an image of an image pickup target 3 by an image sensing element 12 and generating an image signal 31.

S22: Receiving the image signal 31 by a microcontroller 13.

S23: Controlling a focus lens group 11 to move by the microcontroller 13 to change the focus point of forming the image, so as to change a contrast ratio of the image signal 31.

S24: Computing a contrast value of the image signal 31 by the microcontroller 13, such that a process of focusing is achieved when the focus lens group 11 is positioned at a position corresponding to a maximum contrast value of the image signal 31.

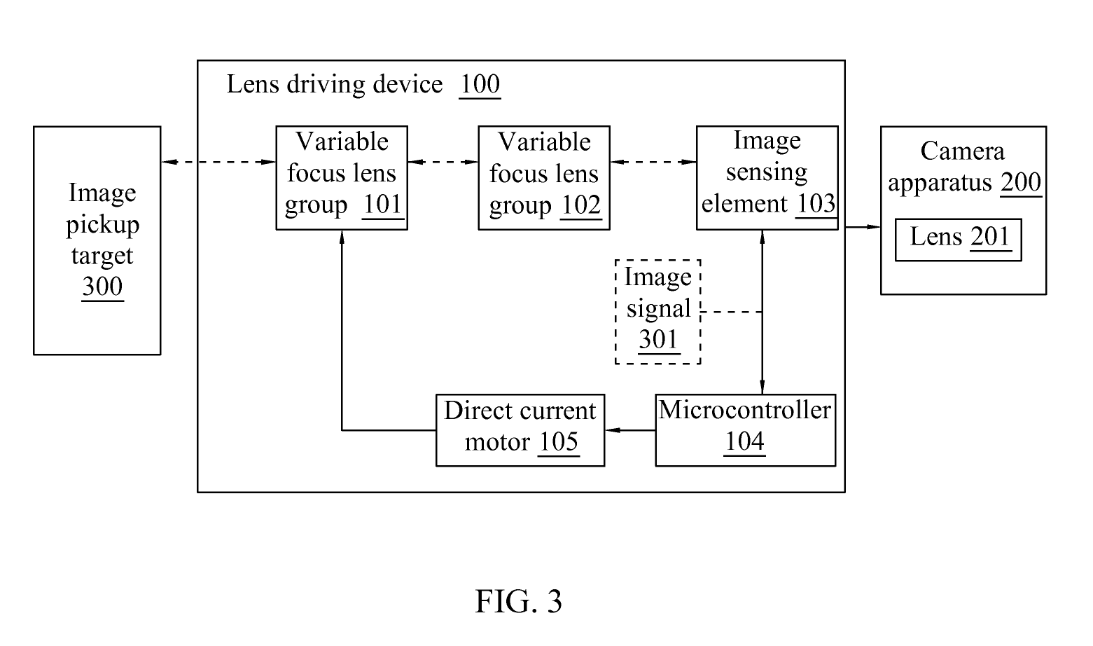

With reference to FIG. 3 for a schematic view of a lens driving device in accordance with the second preferred embodiment of the present invention, the lens driving device 100 is applicable for a camera apparatus 200, and the camera apparatus 200 comprises a lens 201. The lens driving device 100 comprises a zoom lens group 101, a focus lens group 102, an image sensing element 103, a microcontroller 104 and a direct current motor 105. The microcontroller 104 is electrically coupled to the image sensing element 103 for starting the image sensing element 103 to sense an image of an image pickup target 300, and the microcontroller 104 is provided for controlling the direct current motor 105. The direct current motor 105 is provided for driving the zoom lens group 101 and the focus lens group 102. The zoom lens group 101 and the focus lens group 102 are installed in the lens 201 of the camera apparatus 200, and the zoom lens group 101 is installed between the image pickup target 300 and the image sensing element 103, and the focus lens group 102 is installed between the zoom lens group 101 and the image sensing element 103. The image sensing element 103 is provided for sensing the image of the image pickup target 300 and generating an image signal 301 accordingly. The zoom lens group 101 is provided for adjusting the focal length of the lens 201 to change the distance of forming the image. The focus lens group 102 is provided for changing the focus point of forming the image. Wherein, if the direct current motor 105 drives the zoom lens group 101 and the focus lens group 102, the focus lens group 102 remains still when the zoom lens group 101 moves, and the zoom lens group 101 remains still when the focus lens group 102 moves.

In the second preferred embodiment, if the microcontroller 104 receives the image signal 301 sensed by the image sensing element 103, the direct current motor 105 will be controlled to drive and move the zoom lens group 101 and change the distance of forming the image, so as to complete a zoom motion, or the microcontroller 104 controls the direct current motor 105 to drive and move the focus lens group 102 and change the focus point of forming the image, so as to change a contrast ratio of the image signal 301, and the microcontroller 104 then computes a contrast value according to each sampled image signal. The process of focusing may be achieved while the microcontroller 104 controls the direct current motor 105 to drive the focus lens group 102 to move to the position corresponding to a maximum contrast value of the image signal 301.

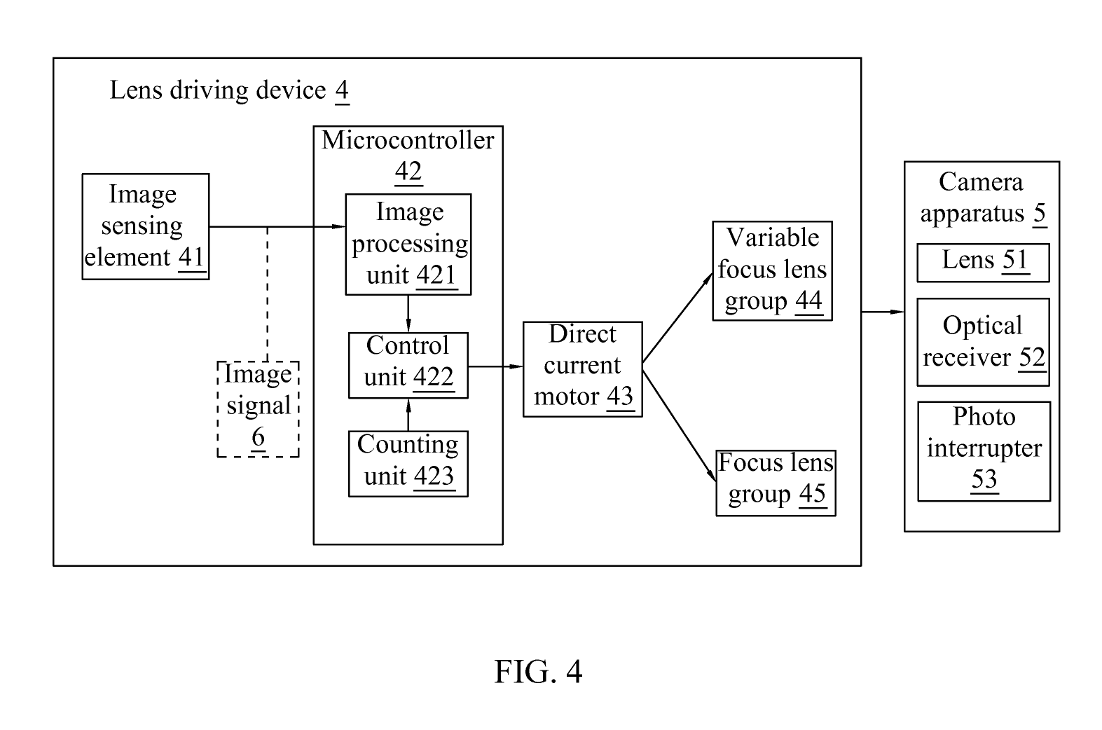

With reference to FIGS. 4, 5 and 6 for the first schematic view, second schematic view and third schematic view of a lens driving device in accordance with the third preferred embodiment of the present invention respectively, the lens driving device 4 comprises an image sensing element 41, a microcontroller 42, direct current motor 43, a zoom lens group 44 and a focus lens group 45. The microcontroller 42 is electrically coupled to the image sensing element 41 and provided for controlling the direct current motor 43 to drive and move the zoom lens group 44 and the focus lens group 45. The microcontroller 42 further comprises an image processing unit 421, a control unit 422 and a counting unit 423. The image processing unit 421 is provided for reading and processing an image signal 6 sensed by the image sensing element 41. The control unit 422 is provided for controlling the direct current motor 43. The counting unit 423 is provided for counting a PI signal which may be used as the positioning signal of the present invention. The lens driving device 4 can be installed in a camera apparatus 5 such as a digital camera and a single-lens reflex camera, and the zoom lens group 44 and the focus lens group 45 can be installed in a lens 51 of the camera apparatus 5. The camera apparatus 5 further comprises an optical receiver 52 and a photo interrupter 53.

In the third preferred embodiment, when the camera apparatus 5 is turned on, a process of positioning a PI signal may be carried out. During a focusing process when a user switches the focal length of the lens 51, the control unit 422 controls the direct current motor 43 to rotate to drive and move the zoom lens group 44, and the counting unit 423 counts the PI signal to confirm a zoom position, so as to complete the zoom motion. After the zoom position is confirmed, the image processing unit 421 starts reading an image signal 6 and computes the current contrast value of the image signal 6, and the control unit 422 drives the direct current motor 43 to drive the focus lens group 45 to move back and forth to perform a scan of the contrast value of the image signal 6 to find a maximum contrast value, which corresponds to the focus point of the image. After the position the focus lens group 45 is positioned to a position that the image is sharp and clear, the process of focusing is the considered to be completed. Wherein, the zoom lens group 44 and the focus lens group 45 driven by the direct current motor 43 are not moving at the same time. In other words, when the direct current motor 43 drives and moves the zoom lens group 44, the focus lens group 45 will remain still; and when the direct current motor 43 drives and moves the focus lens group 45, the zoom lens group 44 will remain still.

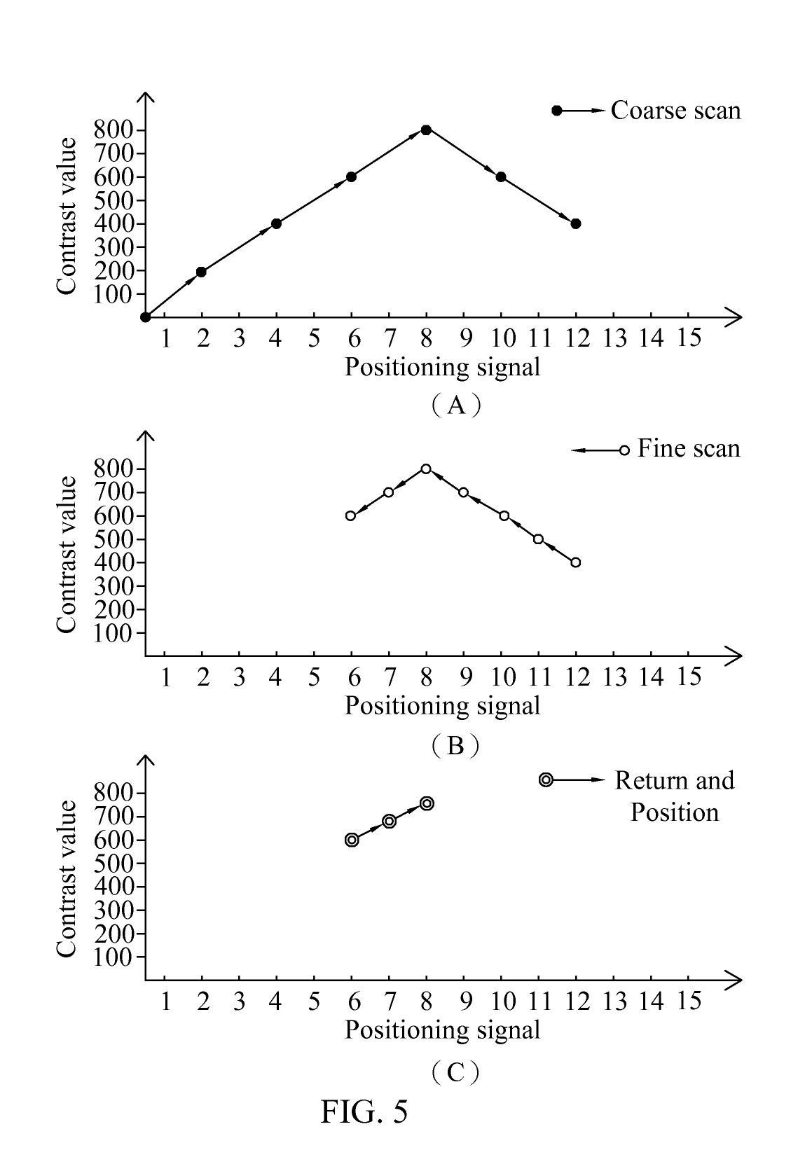

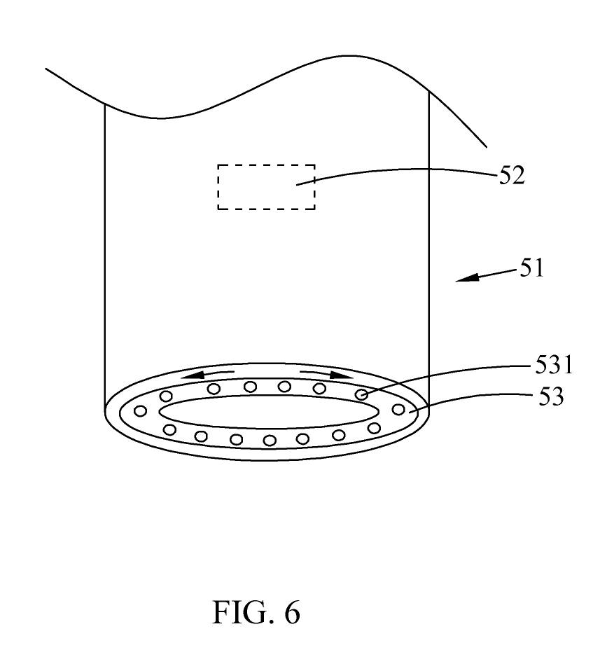

In the third preferred embodiment, the process of focusing primarily uses the microcontroller 42 to control the direct current motor 43 to drive the focus lens group 45 to move back and forth to complete the process of focusing. In FIGS. 5 and 6, the microcontroller 42 for controlling direct current motor 43 drives a lens 51 to rotate to the left side, such that the focus lens group 45 is moved in a direction to perform a coarse scan. In the process of the coarse scan, the focus lens group 45 is moved in one direction to change the contrast ratio of the image signal 6, and the microcontroller 42 samples the image signal 6 with a first interval of a positioning signal (PI signal), and the sampled image signal 6 corresponding to each first interval is used to compute a contrast value as shown in FIG. 5A. Wherein, the positioning signal is a light source reading produced by the LED lamp 531 of the photo interrupter 53 received by the optical receiver 52 of the camera apparatus 5 while the lens 51 is rotated, and the first interval has a gap equal to two grids of an LED lamp 531, and the microcontroller 42 takes samples of the image signal 6 and computes the contrast values thereof according to the positioning signal standing for the interval of two grids of the LED lamp 531. In other words, when the direct current motor 43 drives the lens 51 to rotate for the interval of two grids of the LED lamp 531 (or the first interval), the focus lens group 45 moves in such interval, and the microcontroller 42 computes a positioning signal according to the light source of the LED lamp 531 received by the optical receiver 52, and then computes a contrast value corresponding to the position of the positioning signal of the first interval until a coarse scan maximum contrast value is obtained, so as to complete the process of coarse scan.

In the description above, whether or not the coarse scan maximum contrast value is obtained is determined by the contrast value before decrementing the maximum numeric value of the contrast ratio by the microcontroller 42 when the numeric value of the contrast value is changed from an incrementing status to a decrementing status. If the microcontroller 42 obtains the coarse scan maximum contrast value, or the contrast value is decremented from the coarse scan maximum contrast value to a predetermined degree, the microcontroller 42 will control the direct current motor 43 to drive the lens 51 to rotate to the right side, such that the focus lens group 45 is moved in the opposite direction to perform a process of fine scan. Now, the focus lens group 45 is moved in the opposite direction to change the contrast ratio of the image signal 6, and the microcontroller 42 takes samples of the image signal with a second interval according the positioning signal, and the sampled image signal 6 corresponding to each interval is used to compute a contrast value. In addition, the microcontroller 42 will record the positioning signal corresponding to each contrast value as shown in FIG. 5B. Wherein, the second interval in this example is a grid of an LED lamp 531, and the microcontroller 42 uses the interval of each grid of the LED lamp 531 to compute the contrast value and records the corresponding positioning signal. When the numeric value of the contrast value is changing from an incrementing status to a decrementing status, the microcontroller 42 will take the maximum numeric value right before changing to the decrementing status as a fine scan maximum contrast value. Since the second interval is smaller than the first interval, the fine scan maximum contrast value should be greater than or equal to the coarse scan maximum contrast value. In this preferred embodiment, the fine scan maximum contrast value is equal to the coarse scan maximum contrast value.

In the process of fine scan as described above, the microcontroller 42 computes and records the positioning signal corresponding to each contrast value, so that when the microcontroller 42 obtains the fine scan maximum contrast value, or the contrast value is decremented from the fine scan maximum contrast value to a predetermined degree, the microcontroller 42 will control the direct current motor 43 to drive the lens 51 to rotate to the left side again according to the recorded positioning signal, so as to make the focus lens group 45 return to a position of the fine scan maximum contrast value of the image signal 6 as shown in FIG. 5C, so as to complete the process of focusing. The fine scan maximum contrast value is the maximum contrast value of the image signal 6. Wherein, the gaps of the first interval and second interval of the third preferred embodiment are used as examples for illustrating the invention, but the microcontroller 42 can also use three grids or four grids of the LED lamp 531 for the gap to compute the contrast value. The preferred embodiment is not intended for limiting the scope of the present invention. In addition, the direct current motor 43 controls the direction of rotating the lens 51, and the rotating direction of the lens 51 is not limited to the left side only, but the lens 51 can be rotated to the right side for the coarse scan as well.

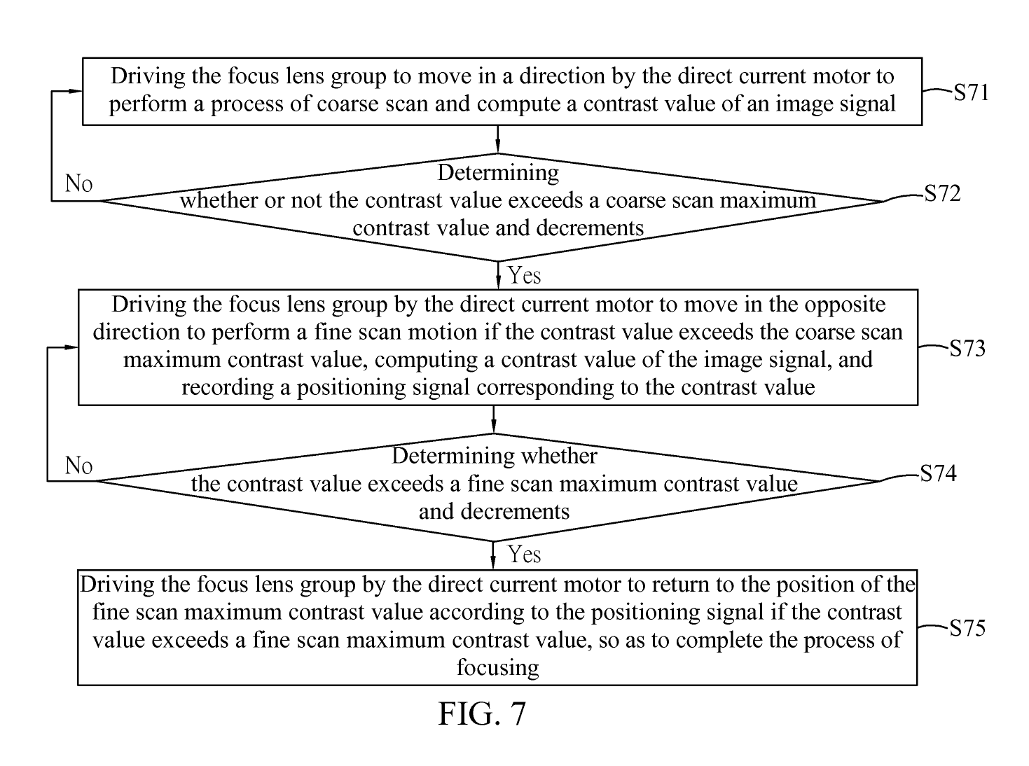

With reference to FIG. 7 for a flow chart of a lens driving method in accordance with the third preferred embodiment of the present invention, the lens driving method comprises the following steps:

S71: Driving the focus lens group 45 to move in a direction by the direct current motor 43 drives to perform a process of coarse scan and compute a contrast value of an image signal 6.

S72: Determining whether or not the contrast value exceeds a coarse scan maximum contrast value and decrements.

S73: Driving the focus lens group 45 by the direct current motor 43 to move in the opposite direction to perform a fine scan motion if the contrast value exceeds the coarse scan maximum contrast value, computing a contrast value of the image signal 6, and recording a positioning signal corresponding to the contrast value.

S74: Determining whether the contrast value exceeds a fine scan maximum contrast value and decrements.

S75: Driving the focus lens group 45 by the direct current motor 43 to return to the position of the fine scan maximum contrast value according to the positioning signal if the contrast value exceeds a fine scan maximum contrast value, so as to complete the process of focusing.

In summary of the description above, the lens driving device and method of the present invention uses a single direct current motor to complete the zooming and focusing functions, and uses a reciprocal scanning method to complete the process of focusing quickly and accurately, not only improving the problems of incurring a higher manufacturing cost of the camera caused by using two motors for the actuation for the zooming and focusing functions, or consuming more battery power of the camera driven by the single stepper motor, but also achieving a quick focusing effect.

What is claimed is:

1. A lens driving device, comprising:
an image sensing element, arranged for sensing an image of an image pickup target and generating an image signal;
a focus lens group, disposed between the image sensing element and the image pickup target, arranged for changing a focus point of forming the image;
a direct current motor, arranged for driving and moving the focus lens group; and
a microcontroller, electrically coupled to the image sensing element, arranged for receiving the image signal and controlling the direct current motor to drive and move the focus lens group to change the focus point of forming the image, so as to change a contrast ratio of the image signal, and the microcontroller computing a contrast value according to the contrast ratio, and the focus lens group is positioned at a position corresponding to a maximum contrast value of the image signal to thereby completing a process of focusing.

2. The lens driving device of claim 1, wherein in the process of focusing, the focus lens group is driven to move in a direction by the direct current motor, and the microcontroller samples and calculates the contrast value of the image signal for every first interval, and while the contrast value is changing from an incrementing status to a decrementing status, the microcontroller takes a maximum numeric value before changing to the decrementing status as a coarse scan maximum contrast value.

3. The lens driving device of claim 2, wherein in the process of focusing, the focus lens group is driven to move in an opposite direction by the direct current motor controlled by the microcontroller when the microcontroller obtains the coarse scan maximum contrast value, and the microcontroller samples and calculates the contrast value of the image signal for every second interval and records a positioning signal corresponding to each of the contrast value, and if the numeric value of the contrast value is changed from the incrementing status to the decrementing status, the microcontroller takes the maximum numeric value before changing to the decrementing status as a fine scan maximum contrast value, and takes the fine scan maximum contrast value as the maximum contrast value, wherein the second interval is shorter than the first interval.

4. The lens driving device of claim 3, wherein the microcontroller controls the direct current motor to drive the focus lens group to move in the opposite direction, while the microcontroller samples at the first interval and the contrast value decrements from the coarse scan maximum contrast value to a predetermined degree.

5. The lens driving device of claim 3, wherein in the process of focusing, the microcontroller controls the direct current motor to drive the focus lens group to return to a position corresponding to the fine scan maximum contrast value of the image signal to complete the process of focusing according to the recorded positioning signal, when the microcontroller obtains the fine scan maximum contrast value.

6. The lens driving device of claim 5, wherein the microcontroller controls the direct current motor to drive the focus lens group to return to the position corresponding to the fine scan maximum contrast value of the image while the microcontroller samples at the second interval and the contrast value decrements from the fine scan maximum contrast value to a predetermined degree.

7. The lens driving device of claim 3, applicable to a camera apparatus, and the focus lens group being installed in a lens of the camera apparatus, wherein the direct current motor drives the lens to rotate, so as to move the focus lens group, and the positioning signal received by an optical receiver of the camera apparatus is a light source reading while the lens is rotated.

8. The lens driving device of claim 1, further comprising a zoom lens group, and the microcontroller drives and moves the zoom lens group to perform a zoom motion, wherein the microcontroller drives the focus lens group and the zoom lens group, such that if the direct current motor drives and moves the focus lens group, the zoom lens group remains still, and vice versa.

9. A lens driving method, comprising the steps of:
sensing an image of an image pickup target by an image sensing element and generating an image signal;
receiving the image signal by a microcontroller;
controlling a direct current motor by the microcontroller to drive and move a focus lens group, so as to change a focus point of forming the image and change a contrast ratio of the image signal; and
computing a contrast value according to the contrast ratio by the microcontroller, and completing a process of focusing when the focus lens group is positioned at a position corresponding to a maximum contrast value of the image signal.

10. The lens driving method of claim 9, wherein the process of focusing further comprises the steps of: using the direct current motor to drive the focus lens group to move in a direction; and sampling and calculating the contrast value of the image signal for every first interval by the microcontroller, and while the numeric value of the contrast value is changing from an incrementing status to a decrementing status, the microcontroller takes a maximum numeric value before changing to the decrementing status as a coarse scan maximum contrast value.

11. The lens driving method of claim 10, wherein the process of focusing further comprises the step of driving the focus lens group to move in an opposite direction by the direct current motor controlled by the microcontroller when the microcontroller obtains the coarse scan maximum contrast value, and sampling and calculating the contrast value of the image signal for every second interval by the microcontroller and recording a positioning signal corresponding to each of the contrast value, and if the numeric value of the contrast value is changed from the incrementing status to the decrementing status, the microcontroller takes the maximum numeric value before changing to the decrementing status as a fine scan maximum contrast value, and takes the fine scan maximum contrast value as the maximum contrast value, wherein the second interval is shorter than the first interval.

12. The lens driving method of claim 11, wherein the process of focusing further comprises the step of: controlling the direct current motor by the microcontroller to drive the focus lens group to return to a position corresponding to the fine scan maximum contrast value of the image to complete the process of focusing according to the recorded positioning signal, when the microcontroller obtains the fine scan maximum contrast value.

13. The lens driving method of claim 11, applicable to a camera apparatus, further comprising the step of disposing the focus lens group in a lens of the camera apparatus, wherein the direct current motor drives the lens to rotate, so as to move the focus lens group, and the positioning signal received by an optical receiver of the camera apparatus is a light source reading while the lens is rotated.

14. The lens driving method of claim 9, further comprising the step of: using the microcontroller to control the direct current motor to drive a zoom lens group to move and perform a zoom motion;
wherein, the microcontroller for controlling the direct current motor drives the focus lens group and the zoom lens group, such that if the direct current motor drives the focus lens group to move, the zoom lens group remains still, and vice versa.

15. A lens driving device, applicable for a camera apparatus, comprising:
an image sensing element, for sensing an image of an image pickup target and generating an image signal;
a zoom lens group, disposed in a lens of the camera apparatus between the image sensing element and the image pickup target, for adjusting the focal length of the lens to change a distance of forming the image;
a focus lens group, disposed in the lens of the camera apparatus between the zoom lens group and the image sensing element, for changing the focus point of forming the image;
a direct current motor, for driving and moving the zoom lens group and the focus lens group; and
a microcontroller, electrically coupled to the image sensing element, for receiving the image signal, and controlling the direct current motor to drive and move the zoom lens group, so as to change the distance of forming the image for completing a zoom motion, or controlling the direct current motor to drive and move the focus lens group, so as to change the focus point of forming the image and change a contrast ratio of the image signal, and the microcontroller computing a contrast value according to the contrast ratio to position the focus lens group to a position corresponding to a maximum contrast value of the image signal, thereby completing a process of focusing.

16. The lens driving device of claim 15, wherein the process of focusing comprises the steps of driving the focus lens group to move in a direction by the direct current motor, sampling and calculating the contrast value of the image signal for every first interval by the microcontroller, and while the numeric value of the contrast value is changing from an incrementing status to a decrementing status, the microcontroller takes a maximum numeric value before changing to the decrementing status as a coarse scan maximum contrast value.

17. The lens driving device of claim 16, wherein the process of focusing further comprises the steps of driving the focus lens group to move in an opposite direction by the direct current motor controlled by the microcontroller when the microcontroller obtains the coarse scan maximum contrast value, and sampling and calculating the contrast value of the image signal for every second interval by the microcontroller and recording a positioning signal corresponding to each of the contrast value, and if the numeric value of the contrast value is changed from the incrementing status to the decrementing status, the microcontroller takes the maximum numeric value before changing to the decrementing status as a fine scan maximum contrast value, and takes the fine scan maximum contrast value as the maximum contrast value, wherein the second interval is shorter than the first interval.

18. The lens driving device of claim 17, wherein the process of focusing further comprises the step of: controlling the direct current motor by the microcontroller to drive the focus lens group to return to a position corresponding to the fine scan maximum contrast value of the image signal according to the recorded positioning signal to complete the process of focusing when the microcontroller obtains the fine scan maximum contrast value.

19. The lens driving device of claim 17, wherein the direct current motor drives the lens to rotate to move the focus lens group, and the positioning signal is a light source reading received by an optical receiver of the camera apparatus while the lens is rotated.
